(19) United States
(12) Patent Application Publication
(10) Pub. No.: US 2013/0055485 A1
(43) Pub. Date: Mar. 7, 2013

(54) PROCESS FOR RESIN APPLICATION FOR THE TREATMENT, WITH OR WITHOUT DURABLE SHAPE-MEMORY, OF READY-MADE COTTON AND MIXED COTTON GARMENTS

(71) Applicants: Tito Zanetta, Milano (IT); Fabio Chiozza, Milano (IT); Luca Cappellini, Serravalle (SM); Andrea Bonalumi, Serravalle (SM)

(72) Inventors: Tito Zanetta, Milano (IT); Fabio Chiozza, Milano (IT); Luca Cappellini, Serravalle (SM); Andrea Bonalumi, Serravalle (SM)

(73) Assignees: GARMON S.P.A., Serravalle (SM); VINAVIL S.P.A., Milano (IT)

(21) Appl. No.: 13/637,849

(22) PCT Filed: Mar. 31, 2011
(86) PCT No.: PCT/IB2011/051388

§ 371 Date: Nov. 14, 2012

(30) Foreign Application Priority Data
Apr. 1, 2010 (IT) MI2010A000558

(51) Int. Cl. C09D 183/06; B05D 3/02; A41D 1/00; B05D 7/00

(52) U.S. Cl. 2/69; 524/806; 427/389.9

(57) ABSTRACT

Disclosed are a process and a crosslinking dispersion formulation based on acrylic copolymers which enable garment fabrics to be treated to produce “distressed” and “raw/unwashed” effects, and enhance the fabric by fixing the colour and giving it a more “compact, brighter” appearance.

The present invention relates to a resin-coating process for treating garments made of cotton or cotton blends, with or without shape memory. Due to the use of suitable crosslinking dispersions, the process according to the invention gives the garment excellent performance in terms of “distressed” and “raw/unwashed” effects, and enhances the fabric in general.

The invention also relates to formulations in the form of dispersions of suitable crosslinking polymers or resins applicable to the resin-coating process.

The combination of polymer dispersion and resin-coating process also simplifies the process, reduces energy requirements and eliminates the potentially harmful products present in the techniques commonly used.

### BACKGROUND OF THE INVENTION

A fashion trend which has been popular since the 1980s is the treatment of garments to produce a “distressed” or “artificially aged” look: this term means a garment which looks as if it had already been worn for a long time or is made of a “raw” fabric, ie. one that has never been washed.

The term “garments” in the present description identifies fabrics sewn to make garments such as jeans, trousers, shirts, jackets, sweaters and all personal clothing items in general.

Different types of sewing, shape, colour and treatments come under the heading of “fashion”, varying in their specificity and over time.

To obtain “distressed”, “already worn”, or “raw” effects, treatments with suitable polymers or resins are often used.

The purpose of these treatments is to freeze the image and/or shape of the garment at the time when the resin or mixture of resins or polymers was applied and crosslinked.

One example of said effect is a pair of trousers which, after being worn for a long time, acquires creases at hip level, behind the knees, down the legs, at the hem, etc.; this effect, which is due to “deformation” of the fabric, can be replicated on a new pair of trousers using said resins.

Another effect obtainable with resin-coating is to enhance the fading effect on the parts of a garment subject to wear: for example, the parts of trousers most subject to wear are the seat and knees, while on a jacket or sweater or shirt, the greatest wear is at the elbows.

All the effects described above are enhanced when effected on jeans made of denim dyed with an indigo dye, as they readily acquire a distressed look; they are therefore among the main garments treated with the known resin-coating/forming methods to meet the growing market interest.

The resins used are mainly glyoxal resins (dimethylol-dihydroxy-ethyleneurea and derivatives thereof) or aqueous emulsions of acrylic polymers or aqueous dispersions of polyurethanes.

The best results are obtained with glyoxal resins alone, but often, due to the aggressiveness of these resins towards cotton, it is preferred to reduce their use and replace them wholly or partly with acrylic or polyurethane polymers in emulsion/aqueous dispersion.

The constituents of the system are used in concentrations ranging from 1 to 150 g/l for non-catalysed glyoxal resins, 1 to 35 g/l for the glyoxal resin catalyst, and 1 to 400 g/l for catalysed glyoxal resins, acrylic resins (30%-60% of dry residue) and polyurethane resins (30%-50% of dry residue).

The crosslinking system can be applied to the whole of the garment or only to particular areas in which the “already worn” or “distressed” effect is to be obtained. It is also convenient to treat the whole garment with resin, and treat the points where said effects are to be obtained at a higher concentration.

After treatment, the amount of dry resin on the trousers is between 3 g and 90 g, and preferably between 15 g and 40 g.

The resins described above, and mixtures thereof, can be applied by “spraying” or “impregnation”: spray application is generally effected by placing the garment on a dummy and airbrushing the resin evenly or locally onto the garment. The use of a dummy ensures optimum distribution of the resin. Impregnation is performed by wetting the garment with a resin solution, either manually, in a washing machine, or by other methods.

Impregnation is generally followed by a stage of wringing, centrifuging or dripping which allows the residual quantity of resin applied to the garment to be regulated.

To obtain “distressed” effects, the application of the resin is followed by a forming stage in which the garment is given the characteristic shape of a garment that has already been worn; the forming stage involves introducing creases into the areas in which they would form during wear. In the case of trousers, the creases are made in the hip area, behind the knees and in the lower part of the leg in contact with the shoes; in the case of jackets they are made at the front of the elbow, etc. The creases are formed manually or using inflatable or jointed dummies which simulate natural creases. The forming stage must be followed by a drying stage so that the creases are fixed. Creases are sometimes formed on tables or supports which facilitate the operator's manual work; in this case the creases are fixed using clothes pegs, jointed tubes, etc. The drying stage can be performed directly on the dummies used to pre-form the garment (in a static oven or with machines such as BOHEMIA® made by Tonello spa, MARGHERITA® made by Mactec s.r.l., etc.), in a static oven with the garments hanging up, in conveyor-belt ovens with the garments hanging up, in conveyor belt ovens with garments laid down flat, etc. The typical drying temperatures are between 30 and 120° C. for 10-40 minutes. When drying is finished, the garments must undergo a crosslinking or post-curing stage; this is a crucial operation to guarantee that the effects will withstand subsequent domestic washing, and is generally performed in static ovens or conveyor belt ovens.

Crosslinking is carried out by acid catalysis using, for example, magnesium chloride at temperatures exceeding 100° C. This post-curing process is critical to obtain the desired effect, because it must take place without damaging the structural resistance of the garment. In fact, excessively low temperatures and/or short times do not guarantee complete crosslinking, leaving excessive formaldehyde residues on the fabric (mainly due to glyoxal resins, but also partly to acrylic resins), and do not guarantee that the creases will last or withstand domestic washing; excessively high temperatures guarantee lasting creases, but the chemical reaction of the glyoxal resin is aggressive to the cotton fibre, thus prejudicing the final strength of the fabric.

If garments with a “raw/unwashed” appearance are to be obtained, the same operations as described above are performed, but without forming creases. In this case the aim is to “fix” the colour, which lasts longer on the fabric after repeated domestic washes. This type of treatment is usually performed on denim jeans dyed with indigo dye.

Typical crosslinking or post-curing temperatures are between 120° C. and 180° C. for a period of 3 to 40 minutes.

EP 0 976 865, assigned to Levi Strauss & Co., discloses a forming process that involves spraying “Reacel KT”® glyoxal resin, made by GARMON S.p.A., on particular areas of the garment, drying at 80° C. and finishing (post-curing) at high temperatures (approx. 180° C.) for short times (2 to 4 mins.).

U.S. Pat. No. 5,948,120, assigned to Sights Denim Systems, discloses a process wherein the garment is positioned on a support (dummy), placed in the desired positions, sprayed with a resin based on dimethylol dihydroxy ethylene urea catalysed by magnesium chloride, and conveyed to the finishing heat treatment, which is performed at temperatures of between 135° C. and 160° C.

The prior art normally applied in the industry presents a series of critical factors which derive from a post-curing process that is not ideal. These drawbacks are described below.
The post-curing stage, performed in ovens containing several cubic metres of air to be heated to and maintained at 140-160° C. for long periods, uses a great deal of energy.
The industrial size of the oven does not allow the required uniformity of temperature, so cases of incomplete crosslinking (temperature too low) or abnormal interaction between the resin and the fabric (temperature too high) are frequent. In both cases, defects may arise, which will become particularly evident at the subsequent processing stages.
The crosslinking process can be performed in different times, leading to different degrees of efficacy, even on the same garment, due to its positioning in the oven, the tendency of the resin to migrate downwards, and the presence of double parts (especially seams) and metal accessories, where heat shock is greater.
Traces of residues from the preceding processes, especially alkaline residues, partly inhibit the effect of the glyoxal resins. Said inhibition prevents the desired final effect from being wholly or partly obtained, and also prevents complete crosslinking of the resin.

After the resin-coating, depending on the types of resins used, different fabric gloss and brightness effects, modifications to colour shade, different tactile effects and hand-feel can be obtained.

The garments thus treated are then sandpapered, sand-blasted, brushed, washed, dyed and softened in accordance with the usual laundry procedures.

These post-resin-coating treatments tend to weaken the fabric further, and in many cases cause it to tear even after a relatively short period of use by the consumer.

The lower the resistance of the fabric before resin-coating, the more evident this problem will be, in particular for light fabrics and/or those which have undergone treatments that have already partly damaged their mechanical strength.

The problem indicated above currently constitutes a very high industrial and commercial risk for operators in the industry.

A further significant problem with the conventional resin-coating process is the presence on the garment of free formaldehyde, a compound considered potentially hazardous to the health, which arises when glyoxal and/or ureic resins are used. This phenomenon is particularly evident in the case of incomplete crosslinking of the resin caused, for example, by traces of alkalinity. Formaldehyde must be absent, or not exceed given limits, for children's clothing in particular.

### DESCRIPTION OF THE INVENTION

It has now been discovered that the limitations of the prior art can be overcome by using a process that employs an acrylic copolymer resin containing specific functions which give the treated garment ideal characteristics very similar to those of the current technology. The process to which the invention relates is advantageous in energy and environmental terms, and reduces the number of rejects.

The present invention relates to the application of a particular resin which is crosslinkable at temperatures lower than 100° C. and is therefore able to confer on garments the same effects as obtainable with the resins which have been used to date, completely eliminating the drawbacks and problems encountered with the industrial processes described above.

The resin-coating products used according to the invention to treat garments in order to obtain “distressed” and “raw/unwashed” effects are mainly dispersions of acrylic copolymers self-crosslinkable at room temperature, possibly with the addition of other chemical additives which improve the application and crosslinking process.

A first aspect of the invention relates to a process for resin-coating of garments, with or without shape memory, which comprises:
a) applying to said garments an acrylic copolymer dispersion containing carbonyl functions and having a Tg of between −50° C. and +50° C.;
b) crosslinking at a temperature of under 100° C.

The resins which can be used in the process according to the invention are obtainable by curing a mixture of monomers consisting of:
60 to 95 parts by weight of (hydroxy) alkyl (metha) acrylate esters;
up to 10 parts by weight of α,β-unsaturated monoolefin amides;
up to 20 parts by weight of unsaturated carboxylic acids;
up to 5 parts by weight of one or more monomers containing carbonyl functions;
optionally up to 5 parts by weight of unsaturated alkoxysilanes.

The (hydroxy) alkyl (metha) acrylate esters are preferably butylacrylate, ethylacrylate, 2-ethylhexylacrylate, methyl methacrylate, butylmethacrylate, 2-hydroxyethylacrylate, and hydroxypropylmethacrylate.

Preferred examples of α,β-unsaturated monoolefin amides include acrylamide, and more preferably methacrylamide.

The unsaturated carboxylic acids are preferably acrylic acid, methacrylic acid and itaconic acid.

The monomers containing carbonyl functions are preferably selected from acetoacetoxyethyl methacrylate, acetoacetoxyethyl acrylate, acetoacetoxy propyl methacrylate, and more preferably diacetone acrylamide.

The unsaturated alkoxysilanes are preferably selected from vinyltrimethoxysilane, 3-methacryloxypropyltrimethoxysilane and vinyltriethoxysilane.

The proportion between the monomers is defined in such a way that the polymer has a Tg of between −50° C. and +50° C., and preferably between −15° C. and +15° C.

In the presence of monomers with a carbonyl function, 0.1 to 5 parts by weight of a crosslinking agent, consisting of polyfunctional organic amines (in a mixture or alone) containing at least two primary or secondary amino groups such as hexamethylenediamine, 1,3-diaminopropane, dodecanediamine, polyoxyalkyleneamine (Jeffamine®), or polycarboxylic acid hydrazides such as adipic dihydrazide or isophthalic dihydrazide, is added to the finished dispersion.

The percentages indicated in the rest of the description are expressed by weight unless otherwise stated.

The dispersion is used in a concentration ranging between 5% and 60%, preferably between 15% and 25%. The crosslinking effect can be enhanced by adding a “blocked isocyanate” product based on diphenylmethane-bis-4,4′-N,N′-ethylene urea (such as Catal LT made by Garmon S.p.A.) in the amount of 0% to 5%, preferably 0% to 2% (percentage by weight of the final formulation) and cross-linked cationic polyalkylene amines (such as polyamide-epichlorhydrin resin such as FST 19 or Linex TS made by Garmon S.p.A.) in the amount of 0 to 10%, preferably 3% to 6%, of the weight of the final formulation.

The dispersion can be further stabilised with non-ionic surfactants, preferably consisting of ethoxylated polystyryl phenols with between 10 and 50 moles of ethylene oxide, preferably between 15 and 25, in the amount of 0 to 5% of the dispersion.

Taking a pair of medium-sized trousers as an example, the area coated by the resin can range between 1300 and 1800 cm², whereas the quantity of dry resin on the trousers is between 10 g and 90 g, and preferably between 30 g and 70 g.

Crosslinking is achieved at the drying stage by condensation of functional groups inserted in the polymer chain or by reaction of suitably functionalised polymer with a crosslinker dispersed in the aqueous phase of the dispersion, at temperatures of between 10° C. and 100° C. This post-curing process produces the desired effect without damaging the structural resistance of the garment at the manufacturing stage.

The dispersion according to the invention is prepared by emulsion polymerisation in jacket-cooled reactors equipped with variable-speed stirrer and condenser, in the presence of radical initiators such as persulphates, peroxides or redox pairs such as persulphates/bisulphites or peroxides/ascorbic acid. The quantity of initiators is established on the basis of the reaction conditions and the desired molecular weight, and ranges between 0.01% and 1% by weight of the total monomers, preferably between 0.01% and 0.1%. Typically, 50%-70% of the initiator is added to the initial reactor charge, while the remainder is fed in, together with the monomers, in a time ranging between 2 and 5 hours.

The stabilising system used during curing contains a combination of different anionic and non-ionic surfactants, in quantities up to 10% by weight of the total monomers, preferably between 3% and 5%. Examples of anionic surfactants include alkylether sulphates, alkyl aryl sulphonates, alkyl ether phosphates, and alkanesulphonate sodium or ammonium salts, and examples of non-ionic surfactants include ethoxylated fatty alcohols and alkylphenol ethoxylates.

The dispersions according to the invention typically have a solid content of between 30% and 70%, preferably between 45% and 55%. The reaction is conducted at temperatures of between 50° C. and 90° C., preferably between 65° C. and 80° C., with an initial load containing up to 50% of the monomers and the remainder being fed in after the primer in 2-5 hours. Further amounts of initiators (thermal or redox) are added at the final stages of the reaction to bring the conversion to values very close to 100%. During the reaction the pH is maintained at between 2 and 4 (preferably between 3 and 4) with the use of buffers such as sodium acetate and sodium bicarbonate, in quantities of up to 0.5% by weight of the total monomers.

The crosslinking agents and stabilisers of the type described above are optionally added to the finished dispersion at ambient temperature.

The resulting formulation, applied by suitable procedures to the garment to be treated, allows the post-curing (or crosslinking) stage to be conducted at a considerably lower temperature than the prior art, and even at ambient temperature.

The physical-chemical characteristics of the formulation allow spray or immersion application in accordance with the current methodologies described above, but allow the post-curing stage to be performed, eliminating the stage in the static or conveyor-belt oven.

On an industrial scale, the crosslinking of the resin can therefore take place during the drying stage, which is normally performed at temperatures below 100° C.

This considerably simplifies all the operations required to prepare the garments for the post-curing stage.

The resin according to the invention presents the following advantages:
it provides a significant energy saving and consequently lower consumption of non-renewable resources and reduction of carbon dioxide emissions;
does not contain formaldehyde, which eliminates the problem of its residues on the garment;
it does not damage or weaken the fabric in any way, thus eliminating all the related problems;
it is not affected by alkaline residues present on the fabric, because it is crosslinked in an alkaline rather than acid medium, unlike the conventional processes currently in use.

To explain the invention more clearly, an example of production of an acrylic dispersion and an example of application showing the final effect obtained according to the invention are set out below.

### EXAMPLE 1

### Preparation Of Dispersion

320 g of water, 1.4 g of Hostapur® SAS 93, 6 g of Rhodapex® AB/20, 0.2 g of sodium bicarbonate and 0.2 g of sodium metabisulphite are loaded into a 3-litre reactor equipped with anchor or gate stirrer, condenser, thermocouple and outer jacket connected to a thermostatic bath. A mixture of monomers containing 320 g of methyl methacrylate, 848 g of butylacrylate, 19 g of acrylic acid, 27 g of vinyl triethoxysilane and 19 g of methacrylamide is added to 330 g of water containing 11 g of Hostapur® SAS 93, 50 g of Polirol® 055 and 36 g of Rhodapex® AB/20, under stirring, to form a pre-emulsion.

The reactor charge is heated to 50° C.; 160 g of pre-emulsion is then added and the reaction is initiated with 0.5 g of sodium persulphate dissolved in 10 g of water. The remainder of the pre-emulsion is then fed into the reactor over 3 hours together with a solution of 0.5 g of sodium persulphate in 60 g of water and a solution of 0.2 g of sodium metabisulphite in 72 g of water. The temperature is maintained at 70-80° C. throughout the reaction. When feeding is complete, additional amounts of initiators are added to complete the conversion of the monomers, maintaining the product at maximum temperature for 60 minutes; it is then cooled to ambient temperature and alkalinised with 15 g of 10% ammonia.

The dispersion has a solid content of 50%, Brookfield RVT viscosity <300 MPA*s (23° C., 20 rpm, spindle 1), coagula at 44 microns <0.03%, pH=7.0-8.0.

### EXAMPLE 2

### Application

1) The garment is placed on an inflatable or jointed dummy, or placed in a washing machine or on other types of machinery to ensure optimum distribution of the resin.
2) 200 g of the dispersion described in example 1 is formulated by adding a mixture of 1.5 g of Soprophor® TS 16 and 1.5 g of Soprophor® S 25 (Rhodia).
3) The garment is impregnated with 203 g of the dispersion formulated as described in paragraph 2), previously diluted in 1 litre of water and with the addition of 50 g of FST 19 or Linex TS and 10 g of Catal LT.
4) The garment undergoes a drying stage (with hot air, heating lamps or the like) for times ranging between 1 and 100 minutes, at temperatures lower than or equal to 100° C. At the end of this operation the garment has a dry resin content of 0.002 g/cm² over the whole of the garment, and 0.02 g/cm² in the areas where the three-dimensional effect, and in any event the “distressed” look, is to appear.
5) The garment then undergoes the usual laundry treatments such as sand-blasting, brushing, sandpapering, stone-washing, softening, dyeing, etc.

The final effect obtained varies widely, according to the type of fabric and pattern used: the best results are obtained with jeans made of denim (or dyed with indigo dye) which have a “distressed” look and, if effected, have creases (also known as “3D whiskers”) in various parts, which withstand domestic washing.

The process according to the invention therefore offers a number of advantages compared with the resin-coating processes known and used:
a. Energy saving.
b. The manufacturing cycle (and consequently the necessary investment) is simplified, thus reducing manufacturing times and manual work.
c. The fabric is not weakened by the type of resin and process normally used.
d. No free formaldehyde is detected on the fabric.
e. The application is not affected by residues of alkaline substances on the fabrics.

1. Process for resin-coating of garments, with or without shape memory, which comprises:
a) placing said garments in contact with a dispersion of acrylic copolymers self-crosslinkable at room temperature and having a Tg of between −50° C. and +50° C., optionally with the addition of non-ionic surfactants, blocked isocyanates and cross-linked cationic polyalkylene amines.
b) crosslinking at a temperature of under 100° C.

2. Process as claimed in claim 1, wherein drying of the garment takes place simultaneously with the crosslinking stage.

3. Process as claimed in claim 1, wherein the acrylic copolymer dispersion is obtainable by curing a mixture of monomers consisting of:
60 to 95 parts by weight of (hydroxy) alkyl (metha) acrylate esters;
up to 10 parts by weight of α,β-unsaturated monoolefin amides;
up to 20 parts by weight of unsaturated carboxylic acids;
up to 5 parts by weight of one or more monomers containing carbonyl functions;
optionally up to 5 parts by weight of unsaturated alkoxysilanes and/or one or more polyfunctional organic amines containing at least two primary or secondary amine groups or polycarboxylic acid hydrazides.

4. Process as claimed in claim 3, wherein the (hydroxy) alkyl (metha) acrylate esters are selected from butylacrylate, ethylacrilate, 2-ethylhexylacrylate, methyl methacrylate, butylmethacrylate, 2-hydroxyethylacrylate and hydroxypropylmethacrylate.

5. Process as claimed in claim 3, wherein the α,β-unsaturated monoolefin amides are selected from acrylamide and methacrylamide.

6. Process as claimed in claim 3, wherein the unsaturated carboxylic acids are selected from acrylic acid, methacrylic acid and itaconic acid.

7. Process as claimed in claim 3, wherein the monomers containing carbonyl functions are selected from acetoacetoxyethyl methacrylate, acetoacetoxyethyl acrylate, acetoacetoxy propyl methacrylate, and diacetone acrylamide.

8. Process as claimed in claim 3, wherein the unsaturated alkoxysilanes are selected from vinyltrimethoxysilane, 3-methacryloxypropyltrimethoxysilane and vinyltriethoxysilane.

9. Self-crosslinkable acrylic copolymer aqueous dispersion obtainable by curing a mixture of monomers consisting of:
60 to 95 parts by weight of (hydroxy) alkyl (metha) acrylate esters;
up to 10 parts by weight of α,β-unsaturated monoolefin amides;
up to 20 parts by weight of unsaturated carboxylic acids;
up to 5 parts by weight of one or more monomers containing carbonyl functions, preferably from 0.1% to 5% by weight of the total monomer mixture, and more preferably from 1% to 3% thereof;
optionally up to 5 parts by weight of unsaturated alkoxysilanes.
optionally non-ionic surfactants, blocked isocyanates and cross-linked cationic polyalkylene amines.

10. Acrylic copolymer dispersion as claimed in claim 9, obtainable by crosslinking in the presence of a crosslinking agent, chosen from one or more polyfunctional organic amines containing at least two primary or secondary amino groups or polycarboxylic acid hydrazides.

11. Dispersion as claimed in claim 10, wherein the polyfunctional organic amines are selected from hexamethylenediamine, 1,3-diaminopropane, dodecanediamine and polyoxyalkylene amine, in quantities ranging between 0.1% and 5% by weight of the total monomer mix.

12. Dispersion as claimed in claim 9, with a solid content of between 30% and 70%, preferably between 45% and 55%.

13. Dispersion as claimed in claim 10, wherein the polycarboxylic acid hydrazides are selected from adipic dihydrazide or isophthalic dihydrazide in the quantity of 0.1% to 5% by weight of the total monomer mixture.

14. Dispersion as claimed in claim 9, also including non-ionic surfactants in the quantity of 0% to 5% by weight, a blocked isocyanate in the quantity of 0% to 2% by weight, and a crosslinked cationic polyalkylene amine in the quantity of 0% to 10% by weight.

15. (canceled)

16. Garments obtainable with the process claimed in claim 1.

17. A process of resin-coating garments with or without memory comprising
obtaining a self-crosslinkable acrylic copolymer as claimed in claim 10; and
treating said garments with said resin.
